(19) United States
(12) Patent Application Publication
(10) Pub. No.: US 2025/0214285 A1
(43) Pub. Date: Jul. 3, 2025

(54) Water-Soluble Sheets and Packages

(71) Applicant: Reckitt Benckiser Finish B.V., Hoofddorp (NL)

(72) Inventors: Alias Younis Al-Bayati, Heidelberg (DE); Torsten Roth, Heidelberg (DE); Jan Maurycy Uszko, Heidelberg (DE)

(21) Appl. No.: 18/847,024

(22) PCT Filed: Mar. 1, 2023
(86) PCT No.: PCT/EP2023/055191

§ 371 Date: Sep. 13, 2024

(30) Foreign Application Priority Data
Mar. 17, 2022 (GB) 2203719.6

(51) Int. Cl. B29C 41/00; B29C 41/12; B29C 48/00; B29C 48/08; B29C 59/00; B29C 59/02; B29C 59/04; B29K 29/00

(52) U.S. Cl. CPC B29C 41/003; B29C 41/12; B29C 48/002; B29C 48/022; B29C 48/08; B29C 59/005; B29C 59/022; B29C 59/04; B29K 2029/04; B29K 2867/003; B29K 2995/0018; B29K 2995/0062; B29K 2995/0074

(57) ABSTRACT

The invention relates to a water-soluble sheet comprising a nanostructured surface pattern having structural features of less than 2 μm.

The invention is further related to a method of manufacturing such a water-soluble sheet having a nanostructured surface pattern having structural features of less than 2 μm, wherein the method comprises contacting a water-soluble sheet with a substrate having a complementary nanostructured surface pattern.

### TECHNICAL FIELD OF THE INVENTION

The present invention relates to water-soluble sheets and packages comprising water-soluble sheets. More specifically, the invention relates to water-soluble sheets having a nanostructured surface pattern and processes for manufacturing the same.

### BACKGROUND TO THE INVENTION

It is known to package chemical compositions which may be of a hazardous or irritant nature in water-soluble or water dispersible materials such as films. The package can simply be added to water in order to dissolve or disperse the contents of the package into the water.

In fields such as detergents for domestic use, an attractive appearance for an article is extremely desirable. Consequently, there is a constant need of consumer products to provide technical and aesthetic differentiation versus the competitor offerings.

It is known to form water-soluble sheets having an improved appearance. For example, US2015273815 discloses an inking-pad printing process of a water-soluble detergent bag and US2008190808 discloses a water-soluble packaging embedded with various security elements which will get irreversibly dissolved and destroyed upon usage of the package in water.

However, a problem associated with the above water-soluble packaging is that there is the need to add additional chemical ingredients to provide the improved appearance, which may cause health hazards and/or affect the properties and performance of the packaging.

It is therefore an aim of the present invention to provide a water-soluble sheet having an improved appearance without having the need to add additional chemical agents.

Moreover, it is an aim of the present invention to provide a water-soluble sheet having improved sealing strength.

It is also an aim of embodiments of the present invention to provide a process for manufacturing a water-soluble sheet having an improved appearance.

It is furthermore an aim of embodiments of the invention, to provide an improved water-soluble package comprising a water-soluble sheet having an improved appearance and/or improved sealing strength.

It is also an aim of embodiments of the invention to overcome at least one problem of the prior art, whether expressly disclosed herein or not.

### SUMMARY OF THE INVENTION

According to a first aspect of the present invention, there is provided a water-soluble sheet having a nanostructured surface pattern having structural features of less than 2 μm.

It has been observed that a water-soluble sheet having a nanostructured surface pattern possesses a unique appearance since upon the incident of polychromatic light onto the surface pattern, the light is diffracted into dispersed colours. This creates a water-soluble sheet having iridescent colour regions. Beneficially, this improves the appearance and distinctiveness of the sheet.

Therefore, polychromatic light incident on the nanostructured surface pattern is diffracted into dispersed colours that are visible on the water-soluble sheet.

The term ‘water-soluble’ is used herein to refer to a material which and at least partially dissolves or disperses in water at 20° C. within 10 minutes. The term ‘water-soluble package’ is used herein to refer to a package which at least partially disperses, disintegrates or ruptures in water at 20° C. within 10 minutes to allow for egress of the contents of the package into the surrounding water.

The term “nanostructured surface pattern” is used herein to refer to patterns having structural features of less than 2 μm. More specifically, the term refers to patterns having physical structural features of less than 2 μm. The structural feature may be any physical feature that has a measurement of less than 2 μm. The measurement may be any physical distance such as a peak height, depression depth, width, length, peak to peak or centre to centre distance, but particularly centre to centre or peak to peak.

The nanostructured surface pattern may be present over the entire surface of the water-soluble sheet. Alternatively, the nanostructured surface pattern may be present over a part of the sheet.

The nanostructured surface pattern may cover between 1 and 100% of the surface of at least one side of the water-soluble sheet, or from 1-50%, or from 1-25%, or from 1-10% of the surface of at least one side of the water-soluble sheet.

The nanostructured surface pattern may be present over the surface of at least one side of the water-soluble sheet. The nanostructured surface pattern may be present over both sides of the water-soluble sheet.

The part of the sheet comprising the nanostructured surface pattern may form a shape on the surface of at least one side of the water-soluble sheet. The shape may be regular or irregular.

The part of the sheet comprising the nanostructured surface pattern may form an image on the surface of at least one side of the water-soluble sheet. The image may be a logo.

The part of the sheet comprising the nanostructured surface pattern may form text on the surface of at least one side of the water-soluble sheet.

The nanostructured surface pattern may comprise one or more protrusions. The protrusion may be a ridge, a cross shaped protrusion, and/or a hexagonal shaped protrusion.

The ridge may be a linear ridge and/or a sinusoidal ridge.

The nanostructured surface pattern may comprise one or more depressions. The depression may be a groove, a cross shaped depression and/or a hexagonal shaped depression.

The groove may be a linear groove and/or a sinusoidal groove.

The nanostructured surface pattern may comprise both protrusions and depressions.

Preferably, the pattern comprises a plurality of protrusions.

The protrusions may be parallel. In preferred embodiments the protrusions comprise parallel protrusions across at least part of the sheet.

The depressions may be parallel. In preferred embodiments, the depressions comprise parallel depressions across at least part of the sheet.

The centre to centre distance between adjacent protrusions and/or depressions may be less than 2 μm. The centre to centre distance may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the centre to centre distance may be from 1-1950 nm, 1-1900 nm, 1-1800 nm, 1-1700 nm, 1-1600 nm, 1 to 1500 nm, 100-1500 nm, 200-1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm 300-1500 nm, 400-1400 nm, 400-1250 nm, 500-1250 nm, 600-1250 nm, 700-1250 nm, 750-1250 nm, 800-1250 nm, 900-1250 nm, 900-1100 nm, 950-1000 nm, or 955-965 nm. Most preferably, the centre to centre distance between the protrusions and/or depressions is 960 nm.

The protrusions and/or depressions may be periodic. In such an embodiment, the centre to centre distance between adjacent protrusions and/or depressions is substantially the same across at least a part of the water-soluble sheet.

The peak height of the protrusions may be less than 2 μm. The peak height may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the peak height may be from 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The depressions may have a depth of less than 2 μm. The depth may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the depression may have a depth of from 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions and/or depressions may have a width of less than 2 μm. The width may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably the protrusion and/or depression may have a width of 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions and/or depressions may have a length of less than 2 μm. The length may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably the protrusion and/or depression may have a width of from 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions may be arranged in a pattern of at least 100, 200, 250, 300, 350, 400, 450, 500, 550, 600, 650, 700, 750, 800, 850, 900, or at least 1000 protrusions per mm and/or no more than 1500, 1450, 1400, 1350, 1300, 1250, 1200, 1150, 1100, 1050, 1025, or no more than 1000 protrusions per mm. Preferably, the protrusions may be arranged in a pattern of 500-1500 protrusions per mm, 750-1250 protrusions per mm, 900-1100 protrusions per mm, or 950-1050 protrusions per mm. Most preferably, the protrusions are arranged in a pattern of 1000 protrusions per mm.

The depressions may be arranged in a pattern of at least 100, 200, 250, 300, 350, 400, 450, 500, 550, 600, 650, 700, 750, 800, 850, 900, or at least 1000 depressions per mm and/or no more than 1500, 1450, 1400, 1350, 1300, 1250, 1200, 1150, 1100, 1050, 1025, or no more than 1000 depressions per mm. Preferably, the depressions may be arranged in a pattern of 500-1500 depressions per mm, 750-1250 depressions per mm, 900-1100 depressions per mm, or 950-1050 depressions per mm. Most preferably, the depressions are arranged in a pattern of 1000 depressions per mm.

In addition to physical structural features of less than 2 μm, the water-soluble sheet may have a surface roughness of less than 0.1 μm.

The water-soluble sheet preferably comprises a water-soluble polymer.

Preferred polymers (including copolymers, terpolymers, or derivatives thereof) suitable for use as a sheet material are selected from polyvinyl alcohols (PVOH), polyvinyl pyrrolidone, polyalkylene oxides, polyacrylamide, polyacrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch, alginate and gelatine, natural gums such as xanthum and carrageenan, and combinations thereof. More preferred polymers are selected from PVOH, polyacrylates and water-soluble acrylate copolymers, methylcellulose, carboxymethylcellulose sodium, dextrin, ethylcellulose, hydroxyethyl cellulose, hydroxypropyl methylcellulose (HPMC), maltodextrin, polymethacrylates, and combinations thereof. Most preferably, the water-soluble polymer may be selected from PVOH, PVOH based copolymers and HPMC, and combinations thereof.

Preferably, the level of polymer in the sheet material, for example a PVOH polymer, is at least 60%. The polymer can have any weight average molecular weight, preferably from about 1000 to 1,000,000, more preferably from about 10,000 to 300,000, yet more preferably from about 20,000 to 150,000.

Preferably, the water-soluble sheet comprises, consists essentially of, or consists of PVOH.

The PVOH sheet may be partially or fully saponified or hydrolysed, for example, it may be from 40 to 100%, preferably 70 to 92%, most preferably about 85% to about 92%, saponified or hydrolysed, PVOH film. The degree of hydrolysis is known to influence the temperature at which the PVOH starts to dissolve in water. 85% hydrolysis corresponds to a sheet soluble in cold (i.e. room temperature) water, whereas 92% hydrolysis corresponds to a sheet soluble in warm water.

It is also possible for suitable additives such as plasticisers, one or more processing aids lubricants, anti-blocking agents and colouring agents to be added to the sheet.

Plasticisers are generally used in an amount of up to 20 wt. %, for example from 10 to 20 wt. %. Lubricants are generally used in an amount of 0.5 to 5 wt. %. The PVOH is therefore generally used in an amount of from 75 to 84.5 wt. %, based on the total amount of the moulding composition. Suitable plasticisers are, for example, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may be used as lubricants. Suitable processing aids include mono-, di-, tri-carboxylic acids/salts thereof, fatty acids such as stearic acid/salts thereof, mono-, di- or triglycerides/salts thereof, fumed silica and inorganic and organic pigments. An anti-blocking agent may also be present in the sheet. Suitable anti-blocking agents include silica, talcum, zeolites and starch.

The water-soluble sheet may be a water-soluble film.

In a second aspect of the present invention, there is provided a method of manufacturing a water-soluble sheet, preferably a water-soluble sheet according to the first aspect of the present invention, having a nanostructured surface pattern, wherein the method comprises contacting a water-soluble sheet with a substrate having a complementary nanostructured surface pattern.

The complementary nanostructured surface pattern of the substrate may comprise one or more depressions.

The depression may be a groove, a cross shaped depression and/or a hexagonal shaped depression.

The groove may be a linear groove and/or a sinusoidal groove.

The complementary nanostructured surface pattern may comprise one or more protrusions.

The protrusion may be a ridge, a cross shaped protrusion, and/or a hexagonal shaped protrusion.

The ridge may be a linear ridge and/or a sinusoidal ridge. Preferably, the pattern comprises a plurality of depressions.

The protrusions may be parallel. In preferred embodiments the protrusions comprise parallel protrusions across at least part of the sheet.

The depressions may be parallel. In preferred embodiments, the depressions comprise parallel depressions across at least part of the sheet.

The centre to centre distance between adjacent protrusions and/or depressions may be at least 1, 2, 5, 10, 25, 50, 75, 100, 150, 200 or at least 250 nm and/or no more than 1500, 1250, 1000, 975, 950, 925, 900, 850, 800 or no more than 750 nm, the centre to centre distance may be from 1-1950 nm, 1-1900 nm, 1-1800 nm, 1-1700 nm, 1-1600 nm, 1 to 1500 nm, 100-1500 nm, 200-1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm 300-1500 nm, 400-1400 nm, 400-1250 nm, 500-1250 nm, 600-1250 nm, 700-1250 nm, 750-1250 nm, 800-1250 nm, 900-1250 nm, 900-1100 nm, 950-1000 nm, or 955-965 nm.

The depressions may have a depth of less than 2 μm. The depth may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the depth may be from 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The peak height of the protrusions may be less than 2 μm. The peak height may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the peak height may be from 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions and/or depressions may have a width of less than 2 μm. The width may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the width may be 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions and/or depressions may have a length of less than 2 μm. The length may be at least 1, 2, 5, 10, 25, 50, 75, 100, 150, 200 or at least 250 nm and/or no more than 1500, 1250, 1000, 975, 950, 925, 900, 850, 800 or no more than 750 nm. Preferably, the length may be 1-1950 nm, 1-1900 nm, 1-1800 nm, 1-1700 nm, 1-1600 nm, 1 to 1500 nm, 250-1950 nm, 250-1900 nm, 250-1800 nm, 250-1700 nm, 250-1600 nm, 250-1500 nm, 250-1400 nm. 250-1300 nm, 250-1250 nm, 250-1000 nm, 450-1000 nm, 500-1000 nm, 600-1000 nm, 700-1000 nm, 800-1000 nm, 900-1000 nm, 250-500 nm, 250-450 nm, 250-400 nm, 300-450 nm, 325-425 nm.

The protrusions and/or depressions may be arranged in a pattern of at least 100, 200, 250, 300, 350, 400, 450, 500, 550, 600, 650, 700, 750, 800, 850, 900, or at least 1000 protrusions and/or depressions per mm and/or no more than 1500, 1450, 1400, 1350, 1300, 1250, 1200, 1150, 1100, 1050, 1025, or no more than 1000 protrusions and/or depressions per mm. Preferably, the protrusions and/or depressions may be arranged in a pattern of 500-1500 protrusions per mm, 750-1250 protrusions per mm, 900-1100 protrusions per mm, or 950-1050 protrusions per mm. Most preferably, the protrusions are arranged in a pattern of 1000 protrusions per mm.

The complementary nanostructured surface pattern may be present over the entire surface of the substrate. Alternatively, the complementary nanostructured surface pattern may be present over a part of the substrate.

The complementary nanostructured surface pattern may cover between 1 and 100% of the surface of at least one side of the substrate, or from 1-50%, or from 1-25%, or from 1-10% of the surface of at least one side of the substrate.

The part of the substrate comprising the complementary nano-structured surface pattern may define a shape on the surface of at least one side of the substrate. The shape may be regular or irregular.

The part of the substrate comprising the complementary nano-structured surface pattern may form an image on the surface of at least one side of the substrate. The image may be a logo.

The part of the substrate comprising the complementary nano-structured may form text on the surface of at least one side of the substrate.

The substrate may be any material that may possess a nanostructured surface pattern.

The substrate may be a metal or polymeric material.

The substrate may be silicon or a silicon derivative.

The metal may be any metal which may possess a nanostructured surface pattern.

In some embodiments the metal may be nickel, aluminium and/or silver.

The polymeric material may be selected from the group consisting of polyethylene terephthalate (PET), polyethylene, polytetrafluoroethylene, polypropylene, duroplast, polyvinyl chloride, polytetrafluoroethylene, polycarbonate, Cyclic olefin copolymer or poly(methyl methacrylate) and polyamide.

The polymeric material may be in the form of a polymer foil.

The substrate pattern may be a diffraction grating.

The nanostructured surface pattern of the substrate may be formed by any suitable patterning method and device known in the art, such as laser interference lithography, photolithography, focused ion beam (FIB), photonic lithography, e-beam lithography, tool machining, ruling engines, diamond turning devices, and any other method or device that can produce nanometer scale features.

Upon contact of the water-soluble sheet with the substrate, an impression or negative of the substrate's nanostructured surface pattern is made on the water-soluble sheet.

This impression or negative may be the form of protrusions or depressions on the surface of the water-soluble sheet, as described in the first aspect.

The nanostructured surface pattern of the water-soluble sheet is complementary to the nanostructured surface pattern of the substrate.

The method may comprise a solution cast process.

In such an embodiment, the method of manufacturing the water-soluble sheet may comprise the steps of
a) providing a substrate having a complementary nano-structured surface pattern;
b) depositing a solution comprising a water-soluble polymer onto the substrate; and
c) drying the solution to form a water-soluble sheet comprising a nano-structured surface pattern.

Preferably, the method further comprises the step of adjusting the thickness of the water-soluble sheet solution during step b).

Preferably, the thickness is adjusted with a doctor blade.

Beneficially, when the thickness of the water-soluble sheet is adjusted in step b) the subsequently prepared water-soluble sheet exhibits improved clinginess.

Alternatively, the method may comprise a cast extrusion process.

In such an embodiment, the method of manufacturing the water-soluble sheet may comprise the steps of
a) providing a mixture comprising a water-soluble polymer;
b) extruding (he mixture through a die;
c) contacting the mixture with a substrate having a complementary nanostructured surface pattern; and
d) forming a water-soluble sheet comprising a nanostructured surface pattern from the mixture.

The substrate in step c) may be a chill roll having a complementary nanostructured surface pattern as described herein.

The mixture may be at least partially liquid in step c).

Alternatively step b) may comprise extruding a water-soluble melt which is subsequently processed to form the film. In such embodiments, step b) may comprise forming a plurality of pellets or granules of the water-soluble mass, and step d) may comprise forming the pellets or granules into a film.

The pellets or granules may be formed by extruding the water-soluble melt, in the form of at least one rope, through a die plate comprising at least one aperture and cutting the or each rope into pellets or granules using a cutting blade or blades, which may be a rotating cutting blade or blades.

The pellets or granules may be passed through a second extruder, which may be a single or twin-screw extruder for example, to form a film.

Alternatively, the method may comprise a blown extrusion process.

In such an embodiment, the blown extrusion process comprises the step of contacting the water-soluble sheet with a substrate having a nanostructured surface pattern.

Alternatively still, the method may comprise embossing a water soluble sheet.

In such an embodiment, the method may comprise the steps of:
a) providing a substrate having a complementary nanostructured surface pattern;
b) depositing a water-soluble sheet onto the substrate; and
c) pressing the water-soluble sheet into the substrate with a sealing plate to form a water-soluble sheet having a nano-structured surface pattern.

The sealing plate may have a temperature of 150-250° C., most preferably 200° C.

The sealing plate may comprise metal.

The method may comprise locating a metal support under the substrate. The metal support may be a mould.

The method may further comprise locating a rubber layer between the sealing plate and the water-soluble sheet. Beneficially, this improves the transfer of the nanostructured surface pattern to the film and prevents any direct metal-metal contact of the sealing plate and the metal support.

In a third aspect of the present invention, there is provided a water-soluble package comprising a water-soluble sheet according to the present invention. The water-soluble sheet may be produced using a method of the second aspect of the invention.

Surprisingly, it has been discovered that a water-soluble package comprising a water-soluble sheet according to the present invention has an improved sealing capability, for example when it is sealed with a further water-soluble sheet which may or may not be of the invention.

The water-soluble package may be a detergent package.

The water-soluble package may be a detergent package having one or more compartments.

The detergent package may be a multi-compartment package.

The nanostructured surface pattern of the water-soluble sheet may be on the areas of the sheet making up the one or more compartments. Preferably, the nanostructured surface pattern will be present on more than one of the compartments, more preferably all of the compartments.

The detergent package may comprise a flange or rim.

The nanostructured surface pattern of the water-soluble sheet may be on the areas of the sheet making up the flange or rim of the detergent package.

In one embodiment, the nanostructured surface pattern may only be present on one or more compartments of the detergent package.

Alternatively, the nanostructured surface pattern may be present on only the flange or rim of the detergent package.

Alternatively, the nanostructured surface pattern may be present on one or more compartments and the flange or rim. More preferably, the nanostructured surface pattern may be present on the flange or rim and all of the compartments.

In a fourth aspect of the invention there is provided a water-soluble package of the third aspect of the invention, containing a composition.

In a fifth aspect of the invention there is provided a method for preparing a water-soluble package, preferably a detergent package, more preferably a multi-compartment detergent package; wherein method comprising the steps of
a) thermoforming a first film, preferably a film according to the first aspect of the present invention, to produce at least one pocket;
b) at least partially filling the or each pocket with a composition; and
c) placing a second film, preferably a film according to the first aspect of the present invention, on top of the or each filled pocket; and
d) sealing the first film and second film together; with the proviso that at least one of first or second film is a film according to the first aspect of the present invention.

In a preferred embodiment thereof, method step c) comprises:
c) placing a second film, preferably a polyvinyl alcohol film, on top of the or each filled pocket; and locating a substrate having a complementary nanostructured surface pattern above the second film;
   and method step d) comprises:
d) sealing the first film and second film together by applying a sealing plate to the substrate to form a water-soluble package having a nanostructured surface pattern.

The pocket may comprise a flange or rim, and the second film may be sealed to the first film at least on the flange or rim.

The composition may be placed in the pocket in step b) and the second film placed on the flange or rim and across the pocket.

Step a) may comprise thermoforming more than one pocket in the film, such as two, three or four pockets. Each pocket may be filled with a different composition, the same composition, or any combination of compositions.

The or each pocket may be completely filled with a composition in step b). Partial filling of each pocket may reduce the risk of rupture of the package, if the package is subjected to shock, and may reduce the risk of leakage if the package is subject to high temperatures.

The films are sealed together in step d), for example by heat sealing across a flange or rim. A suitable heat-sealing temperature is, for example between 120 to 195° C., such as 140 to 160° C. A suitable sealing pressure is, for example, from 800 to 1600 kPa. Examples of sealing pressures are 1000 to 1400 kPa, especially 1100 to 1300 kPa, especially 1200 kPa depending on the heat-sealing machine used. Suitable sealing times are at least 1.5 seconds, for example 1.5 to 2.5 seconds, preferably 2 seconds. Other methods of sealing the films together may be used, for example infrared, radio frequency, ultrasonic, laser, solvent, vibration, electromagnetic, hot gas, hot plate, insert bonding, fraction sealing or spin welding. An adhesive, such as water or an aqueous solution of polyvinyl alcohol may also be used. The adhesive can be applied to the films by spraying, transfer coating, roller coating or otherwise coating, or the films can be passed through a mist of the adhesive. The seal may also be water-soluble.

The first film of the invention may generally have a thickness before thermoforming of 20 to 500 μm, especially 50 to 400 μm, for example 70 to 300 μm, most preferably 70 to 160 μm, especially 80 to 150 μm. The thickness of the second film may be less than that of the first film as the second film may not generally be thermoformed, so localised thinning of the sheet may not occur. The thickness of the second film may generally be from 20 to 150 μm, preferably from 40 to 90 or 100 μm, more preferably from 30 to 90 μm. However, a film having a thickness of 70 to 150 μm may also be used.

The composition filling the packages is not particularly limited. It can be any composition which is to be added to an aqueous system or used in an aqueous environment.

The composition may be a dishwashing composition, water-softening composition, laundry composition, hard surface cleaning composition, concentrated cleaning composition, dilutable cleaning composition or detergent composition or a rinse aid. In this case it is especially suitable for use in a domestic washing machine such as a laundry washing machine or, especially, a dishwashing machine, including an automatic dishwashing machine.

The nature of the composition in each pocket is not limited. It may, for example, be independently a solid, liquid or gel in each pocket. If it is in the form of a solid it may, for example, be in the form of a powder, granules, an extruded tablet, a compressed tablet or a solidified gel. If it is in the form of a liquid, it may be optionally thickened or gelled with a thickener or a gelling agent. One or more than one phase may be present. For example, each pocket may be independently filled with a liquid composition, a separate solid composition, for example in the form of a ball, pill, granules or speckles and a separate gel composition.

Alternatively, two or more solid phases may be present, or two or more immiscible liquid phases.

Thus, the composition in each pocket need not be uniform. For example, during the manufacture at least one pocket could first be filled with a settable composition, for example a gel, and then with a different composition such as a liquid, especially an aqueous, composition, or the compositions could be filled in separate pockets. The first composition could dissolve slowly, for example in a washing process, so as to deliver its charge over a long period. This might be useful, for example, to provide an immediate, delayed or sustained delivery of a component such as a softening agent.

If more than one package is formed at the same time, the packaged compositions may then be separated from each other.

Alternatively, they may be left conjoined, and, for example, perforations provided between the individual packages so that they can be easily separated at a later stage, for example by a consumer or during further processing of the packages.

If the packages are separated, the flanges may be left in place. However, desirably the flanges are partially removed in order to provide an even more attractive, three-dimensional appearance. Generally, the flange remaining should be as small as possible for aesthetic purposes while bearing in mind that some flange is required to ensure the two films remain adhered to each other. A flange of 0.1 mm to 5 mm is desirable, preferably 0.5 mm to 4 mm, more preferably 1 mm to 3 mm, most preferably about 2 mm.

The packages may then be left to absorb water from the atmosphere or may be immediately packaged into boxes for retail sale. The packages may themselves be packaged in outer packages if desired, for example non-water-soluble outer packaging material which is removed before the water-soluble packages are used.

The packages of the present invention generally contain from 5 to 100 g of composition, such as an aqueous composition, especially from 5 to 40 g, depending on their intended use. For example, a dishwashing composition may weigh from 8 to 30 g, a water-softening composition may weigh from 10 to 30 g, and a laundry composition may weigh from 10 to 40 g, especially 10 to 30 g.

The pockets may have any shape. For example, they can take the form of an envelope, sachet, sphere, hemisphere, segment of a sphere, cylinder, cube (including rounded cubes) or cuboid (including rounded cuboids), i.e. a rectangular parallelepiped whose faces are not all equal; or an irregular shape. In general, because the packages are not rigid and are inflated, the sides are not planar, but rather are convex. If the package is formed from a thermoformed film and a planar film, the seam between the two films will appear nearer one face of the package rather than the other. Apart from the deformation of the package due to shrinkage of the polyvinyl alcohol films after the package is manufactured, deformation may also occur at the stage of manufacture if desired. For example, if the pocket is filled with a solid or gelled composition (for example in the form of a tablet) having a height greater than that of the pocket, the second film will be deformed when placed on top of the pocket.

In general, the maximum dimension of the filled part (pocket) of the package (excluding any flanges) is 10 cm×10 cm, preferably 8 cm×8 cm. For laundry detergent compositions, the maximum dimension of the filled part of the package is preferably 8 cm×8 cm, whilst for automatic dishwashing detergent compositions, the maximum dimension may be smaller, such as no more than 6 cm×6 cm, for example.

The composition may contain surface active agents such as anionic, nonionic, cationic, amphoteric or zwitterionic surface active agents or mixtures thereof.

Dishwashing compositions may comprise a detergency builder. The builder is preferably a phosphate-free builder. The builder may comprise one or more small molecule builders selected from hydroxycarboxylates (such as a citrate salt, for example trisodium citrate, which may be anhydrous), aminocarboxylates (such as methyl glycine diacetic acid (MGDA), or N,N-dicarboxymethyl glutamic acid (GLDA), dicarboxylic acid amines (such as iminodisuccinic acid (IDS) and/or phosphates (such as tripolyphosphate), or the salts thereof.

The compositions, particularly when used as laundry washing or dishwashing compositions, may also comprise enzymes, such as protease, lipase, amylase, cellulase and peroxidase enzymes.

The compositions may, if desired, comprise a thickening agent or gelling agent.

The compositions can also optionally comprise one or more additional ingredients. These include conventional detergent composition components such as further surfactants, bleaches, bleach activators, bleach catalysts, bleach enhancing agents, builders, suds boosters or suds. suppressors, anti-tarnish and anticorrosion agents, organic solvents, co-solvents, phase stabilisers, emulsifying agents, preservatives, soil suspending agents, soil release agents, germicides, pH adjusting agents or buffers, nonbuilder alkalinity sources, chelating agents, clays such as smectite clays, enzyme stabilizers, anti-limescale agents, colourants, dyes, hydrotropes, dye transfer inhibiting agents, brighteners and perfumes. If used, such optional ingredients will generally constitute no more than 10 wt. %, for example from 1 to 6 wt. %, of the total weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt. % of the compositions.

The compositions may optionally comprise components which adjust or maintain the pH of the compositions at optimum levels. Examples of pH adjusting agents are NaOH and citric acid. The pH may be from, for example, 1 to 13, such as 8 to 11 depending on the nature of the composition. For example, a dishwashing composition desirably has a pH of 8 to 11, a laundry composition desirably has a pH of 7 to 9, and a water-softening composition desirably has a pH of 7 to 9.

Preferably, the composition is an automatic dishwashing composition.

In a sixth aspect of the present invention, there is provided a method of embossing a water-soluble package with a nanostructured surface pattern.

The method may comprise the steps of
a) preferably plasticising a surface of a water-soluble pouch by contacting the surface with a plasticiser;
b) providing a substrate having a complementary nanostructured surface pattern; and
c) pressing the substrate into the water-soluble pouch, preferably into the water-soluble pouch of method step a), with a sealing plate to form a water-soluble pouch having a nanostructured surface pattern.

The plasticiser may be water, pentaerythritols such as depentaerythritol, sorbitol, mannitol, glycerine and glycols such as glycerol, ethylene glycol and polyethylene glycol.

In one embodiment, the substrate may be a calendaring roll having a nanostructured surface pattern.

In a seventh aspect of the present invention, there is provided the use of a water-soluble sheet according to the first aspect of the present invention to package a composition preferably an automatic dishwashing composition, a detergent composition, a hard surface cleaning composition, a concentrated cleaning composition, a dilutable cleaning composition or a laundry composition.

The further aspects of the present invention may incorporate any of the features of the other aspects of the invention described herein as desired or as appropriate.

### DETAILED DESCRIPTION OF THE INVENTION

In order that the invention may be more clearly understood, one or more embodiments thereof will now be described, by way of example only, with reference to the accompanying drawings, of which:

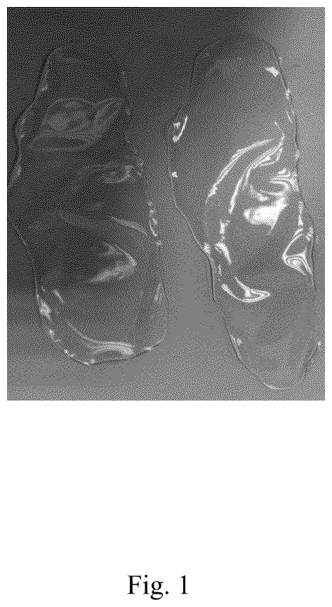

FIG. 1: is an image of a water-soluble sheet according to the present invention described in Example 1 (left) and a water-soluble sheet not according to the present invention described in Reference Example 2 (right).

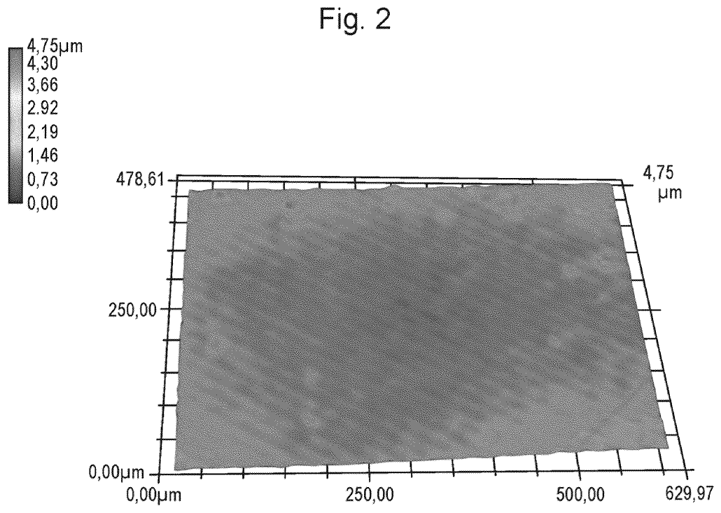

FIG. 2: is a digital microscope (Keyence VHX-7000 with lens VHX-E100) image of a film according to the present invention described in Example 1.

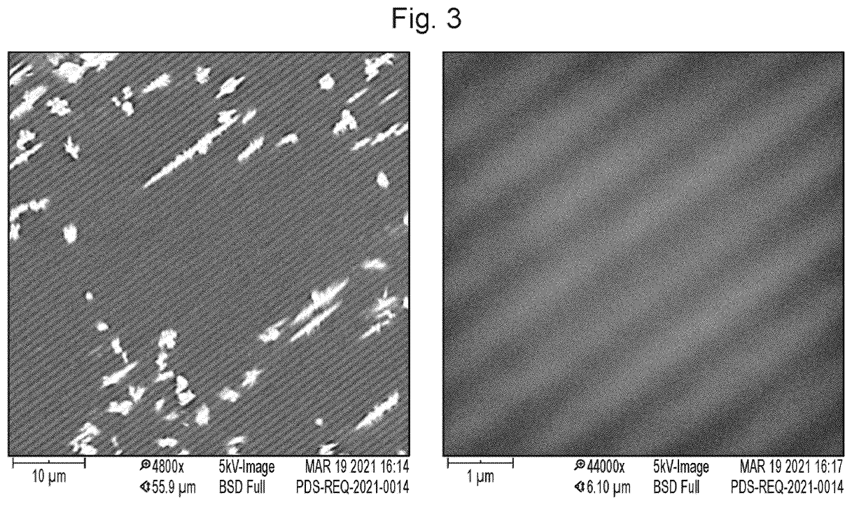

FIG. 3: is a scanning electron microscope image (4800× zoom and 44000× zoom) of a film according to the present invention described in Example 1.

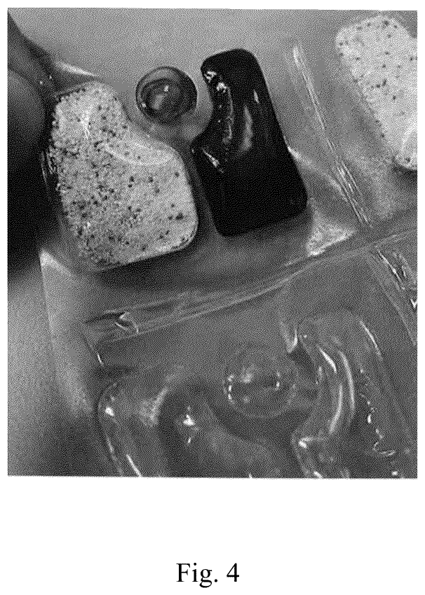

FIG. 4: is an image of a water-soluble package produced from the water-soluble film described in Example 1.

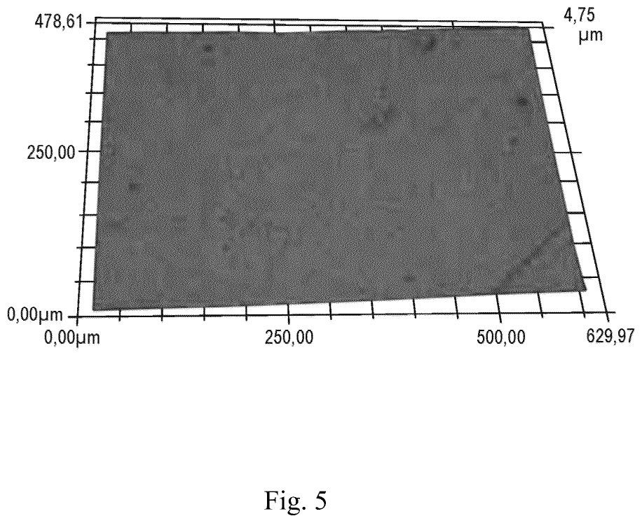

FIG. 5: is a digital microscope image (Keyence VHX-7000 with lens VHX-E100) of a film not according to the present invention described in Reference Example 2.

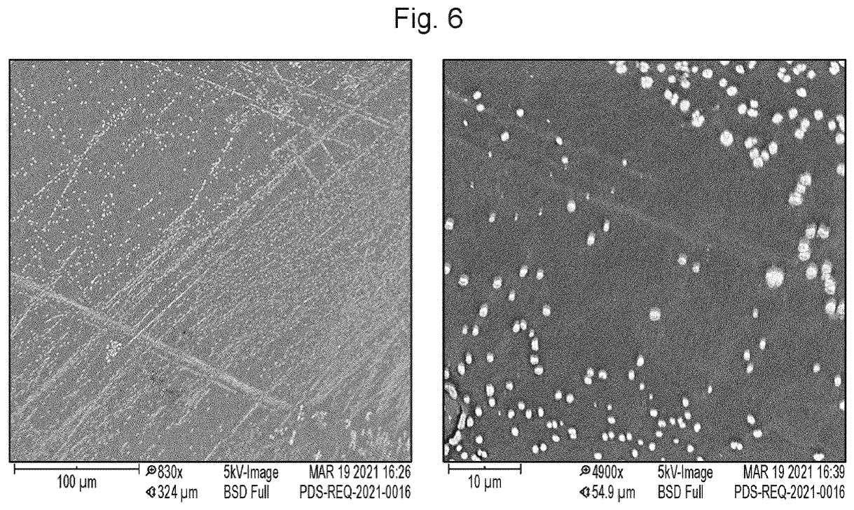

FIG. 6: is a scanning electron microscope image (830× zoom and 4500× zoom) of a film not according to the present invention described in Reference Example 2.

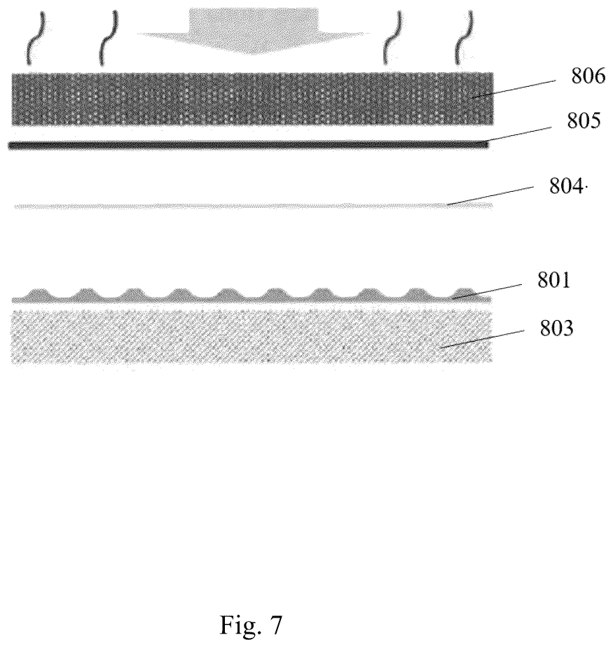

FIG. 7: is a schematic representation of a method of manufacturing a water-soluble film according to the present invention described in Example 4.

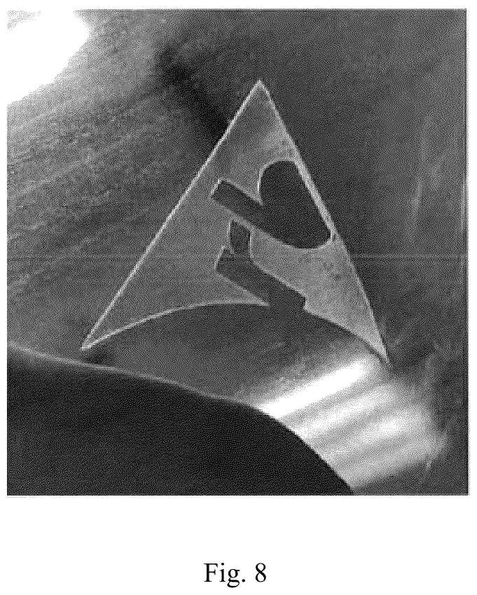

FIG. 8: is an image of a water-soluble film according to the present invention described in Example 4.

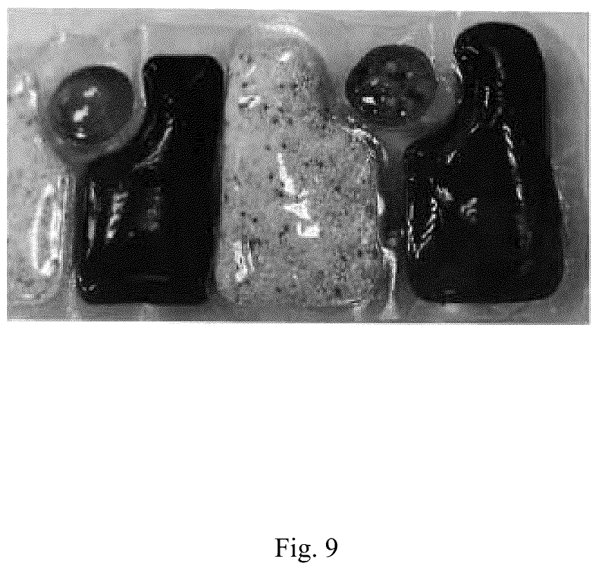

FIG. 9: is an image of a water-soluble package according to the present invention described in Example 5.

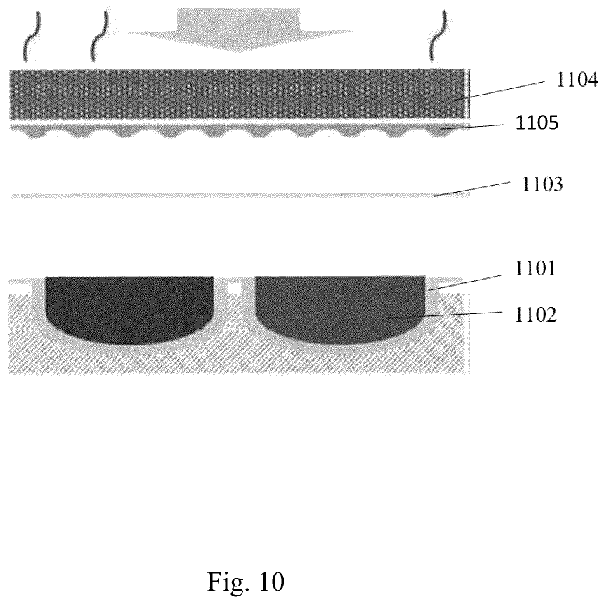

FIG. 10: is a schematic representation of method of manufacturing a water-soluble film according to the present invention described in Example 6.

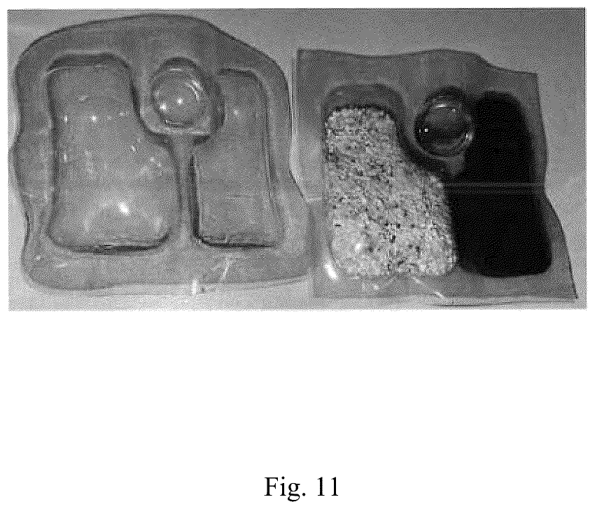

FIG. 11: is an image of a water-soluble package according to the present invention described in Example 6.

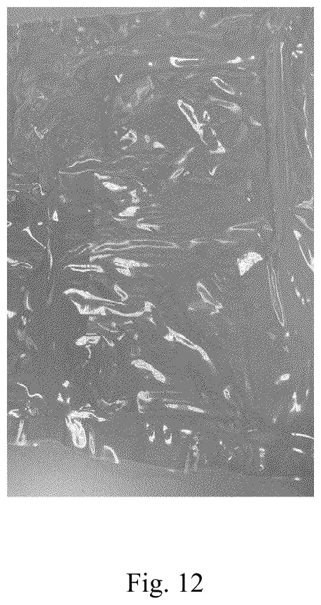

FIG. 12: is an image of a water-soluble sheet produced from the water-soluble film described in Example 7.

### EXAMPLES

### Example 1

5 g of PVOH film (SOLUBLON® GA film) was dissolved in 25 mL of de-ionised water to form a solution. The solution was then cast on a PET diffraction grating (SKU #01503 from Rainbow Symphony), having a surface pattern of 1000 depressions per mm, using film application device COATMASTER 510 Basic-G. The film was left to dry overnight at a temperature of 20° C. and 37% relative humidity to form a water-soluble film having a nanostructured surface pattern. The film obtained by this process is shown in FIG. 1 (left). As shown, the film possesses iridescent colour regions.

Moreover, as shown in FIGS. 2 and 3, when viewed under a digital microscope and scanning electron microscope, the film exhibited protrusions on the surface of the film. The centre to centre distance of adjacent protrusions is around 950-1050 nm.

The film was then processed into a water-soluble package. As shown in FIG. 4, the water-soluble package exhibits iridescent colour regions.

### Reference Example 2

5 g of PVOH film was dissolved in 25 mL of de-ionised water to form a solution. The solution was then cast on a glass surface having no nanostructured surface pattern. The film was left to dry overnight at a temperature of 20° C. and 37% relative humidity to form a water-soluble film. The film obtained by this process is shown in FIG. 1(right). As shown, the film does not possess any iridescent colour regions.

Moreover, as shown in FIG. 5 and FIG. 6, when viewed under a digital microscope and scanning electron microscope the film did not exhibit protrusions on the surface of the film.

### Example 3

A water-soluble film having a nanostructured surface pattern was prepared according to a method of the present invention. As shown in FIG. 7, a PET diffraction grating (801) was placed on a flat metal surface (803) and layered with a PVOH film (804). The PET diffraction grating had a plurality of parallel depressions with a centre to centre distance between adjacent depressions of 1000 nm and an arrangement of 1000 depressions per mm.

The PET diffraction grating (801) only contained a complementary nanostructured surface pattern on a part of its surface. A rubber layer (805) was then located above the PVOH film and a metal heating plate (806) was located above the rubber layer. The metal heating plate (806) was then heated to 200° C. and pressed for 2 seconds onto the PVOH film (804). The resulting film possessed iridescent colour regions on a part of the surface of the film, such that the iridescent colour regions displayed visible text, as shown in FIG. 8.

### Example 4

A water-soluble package having a nanostructured surface pattern was prepared according to a method of the present invention. A PVOH package was placed in a metal mould that was mounted in a thermoformer. Then, the surface of the package was wetted using a cotton swab, sponge or microfibre cloth, and a PET diffraction grating was placed on the moistened pouch. The PET diffraction grating had a plurality of parallel depressions with a centre to centre distance between adjacent depressions of 1000 nm and an arrangement of 1000 depressions per mm. The diffraction grating was pressed into the water-soluble package at a temperature of 200° C. for 2 seconds. The resulting water-soluble package possessed iridescent colour regions as shown in FIG. 9.

### Example 5

A water-soluble package was prepared according to a further method of the present invention. As shown in FIG. 10, a first PVOH film (1101) was thermoformed to a produce a pocket and the pocket was filled with a detergent composition (1102). A second PVOH film (1103) was then placed on top of the filled pocket. A PET diffraction grating (1105) was placed on top of the second PVOH film (1103) in a sealing area and a heating plate (1104) was pressed onto the diffraction grating (1105) at a temperature of 165° C. for 2 seconds to seal the first film (1101) to the second film (1103) to form a water-soluble package having a nanostructured surface pattern. The PET diffraction grating had a plurality of parallel depressions with a centre to centre distance between adjacent depressions of 1000 nm and an arrangement of 1000 depressions per mm. As shown in FIG. 11, the resulting water-soluble package possessed iridescent colour regions in the sealing area.

### Example 6

A Collin ZK 25*42D twin screw extruder was used to prepare a melt at 185° C. from a mixture comprising 20.4% low molecular weight PVOH resin and 56.4% high molecular weight PVOH resin, 22% plasticizers and 1.2% processing aids. The melt was fed with a melt pump to a flat die for extrusions at a speed of from 5 to 15 kg/h. After extrusion the mixture was formed on 2 chrome plated Chill-Rolls to a film. The first Chill-Roll had a cooling temperature of 60° C. and the second Chill-Roll had a cooling temperature of 20° C. The first Chill-Roll had a patch attached with a nanostructured surface pattern. The film was then wounded with a hall-off system to the desired thickness.

As shown in FIG. 12, the resulting water-soluble film possessed a nanostructured surface pattern and iridescent colour regions.

### Reference Example 7

A Collin ZK 25*42D twin screw extruder was used to prepare a melt at 185° C. from a mixture comprising 20.4% low molecular weight PVOH resin and 56.4% high molecular weight PVOH resin, 22% plasticizers and 1.2% processing aids. The melt was fed with a melt pump to a flat die for extrusion at a speed of from 5 to 15 kg/h. After extrusion the mixture was formed on 2 chrome plated Chill-Rolls to a film. The first Chill-Roll had a cooling temperature of 60° C. and the second Chill-Roll had a cooling temperature of 20° C. Neither Chill-Roll possessed a nanostructured surface pattern. The film was then wounded with a hall-off system to the desired thickness.

The resulting water-soluble film did not possess a nanostructured surface pattern and did not possess iridescent colour regions.

### Mechanical Properties

Films with thickness of 90 m were produced according to the method stated in Example 1 and Reference Example 2. The tensile and sealing properties were then tested according to ISO 527-3 and ASTM F88 on a Zwicki-Line testing machine Z1.0. The results are shown in Table 1 below.

TABLE 1

| | Maximum | Elongation | Maximum force till seal |
|---|---|---|---|
| | force/N | at break/mm | destroyed/N |
| Example 1 | 53.2 ± 3.1 | 199 ± 10 | 26.6 ± 0.9 |
| Reference | 52.9 ± 5.3 | 196 ± 15 | 24.5 ± 3.2 |
| Example 2 | | | |

From these results, it can be seen that a PVOH film having a nanostructured surface pattern according to the present invention displays no discernible difference in tensile and sealing properties, while providing the improved aesthetic effect, as shown FIG. 1.

Films with thickness of 90 μm were produced according to the method stated in Example 6 and Reference Example 7. Tensile and sealing properties of these films were then tested according to ISO 527-3 and ASTM F88 on a Zwicki-Line testing machine Z1.0. The results of this test are shown in Table 2 below.

TABLE 2

| | Machine direction | | Transverse direction | | Maximum force |
|---|---|---|---|---|---|
| | Maximum | Elongation | Maximum | Elongation at | till seal |
| | force/N | at break/mm | force/N | break/mm | destroyed/N |
| Example | 89.2 ± 3.8 | 160 ± 6 | 57.3 ± 3.5 | 217 ± 8 | 44.3 ± 5.0 |
| 4 film | | | | | |
| Example | 77.9 ± 9.8 | 136 ± 15 | 52.0 ± 5.7 | 220 ± 15 | 51.8 ± 3.5 |
| 5 film | | | | | |

As shown in Table 2, PVOH films having a nanostructured surface pattern produced according to the present invention display no discernible difference in tensile and sealing properties, while providing an improved aesthetic effect.

It is of course to be understood that the present invention is not intended to be restricted to the foregoing examples which are described by way of example only.

1. A water-soluble sheet comprising a nanostructured surface pattern having structural features of less than 2 μm.

2. The water-soluble sheet according to claim 1, wherein, the nanostructured surface pattern is configured such that, in use, polychromatic light incident on the nanostructured surface pattern is diffracted into dispersed colours that are visible on the water-soluble sheet.

3. The water-soluble sheet according to claim 1, wherein the nanostructured surface pattern covers between 1 and 100% of at least one side of the water-soluble sheet, or from 1-50%, or from 1-25%, or from 1-10% of the surface of at least one side of the water-soluble sheet.

4. The water-soluble sheet according to claim 1, wherein the nanostructured surface pattern comprises one or more protrusions and/or depressions.

5. The water-soluble sheet according to claim 4, wherein the protrusions and/or depressions are arranged in a pattern of 500-1500 protrusions and/or depressions per mm; and wherein the water-soluble sheet comprises a polymeric material.

6. A method of manufacturing a water-soluble sheet according to claim 1, having a nanostructured surface pattern having structural features of less than 2 μm, wherein the method comprises contacting a water-soluble sheet with a substrate having a complementary nanostructured surface pattern.

7. The method according to claim 6, wherein the complementary nanostructured surface pattern comprises one or more depressions and/or protrusions; wherein the centre to centre distance between adjacent depressions and/or protrusions is 300-1500 nm.

8. The method according to claim 6, wherein the depressions and/or protrusions of the complementary nanostructured surface pattern are arranged in a pattern of 500 to 1500 depressions and/or protrusions per mm.

9. The method according to claim 6, wherein the complementary nanostructured surface pattern is a diffraction grating.

10. The method according to claim 6, wherein the method comprises a solution cast process, wherein said method comprises the steps of:
a) providing a substrate having a complementary nano-structured surface pattern;
b) depositing a solution comprising a water-soluble polymer onto the substrate; and
c) drying the solution to form a water-soluble sheet comprising a nano-structured surface pattern;
or wherein the method comprises a cast extrusion process, wherein said method comprises the steps of:
a) providing a mixture comprising a water-soluble polymer;
b) extruding the mixture through a die;
c) contacting the mixture with a substrate having a complementary nanostructured surface pattern; and
d) forming a water-soluble sheet comprising a nanostructured surface pattern from the mixture;
or wherein the method comprises embossing a water-soluble sheet, wherein the method comprises the steps of:
a) providing a substrate having a complementary nanostructured surface pattern;
b) depositing a water-soluble sheet onto the substrate; and
c) pressing the water-soluble sheet into the substrate with a sealing plate to form a water-soluble sheet having a nano-structured surface pattern.

11. The method according to claim 10, wherein the method comprising embossing a water-soluble sheet further comprises locating a metal support under the substrate and locating a rubber layer between the sealing plate and the water-soluble sheet.

12. A method for preparing a water-soluble detergent package, the method comprising the steps of:
a) thermoforming a first film to produce at least one pocket;
b) at least partially filling the or each pocket with a composition; and
c) placing a second film on top of the or each filled pocket; and
d) sealing the first film and second film together.

13. The method according to claim 12, wherein method step c) comprises:
c) placing a second polyvinyl alcohol film on top of the or each filled pocket; and locating a substrate having a complementary nanostructured surface pattern above the second film;
and wherein method step d) comprises:
d) sealing the first film and second film together by applying a sealing plate to the substrate to form a water-soluble package having a nanostructured surface pattern.

14. A method of embossing a water-soluble package with a nanostructured surface pattern comprising the steps of:
a. plasticising a surface of a water-soluble pouch by contacting the surface with a plasticiser;
b. providing a substrate having a complementary nanostructured surface pattern; and
c. pressing the substrate into the water-soluble pouch of method step a) with a sealing plate to form a water-soluble pouch having a nanostructured surface pattern.

15. A use of a water-soluble sheet according to claim 1 to package an automatic dishwashing composition, a detergent composition, a hard surface cleaning composition, a concentrated cleaning composition, a dilutable cleaning compositions or a laundry composition.

16. The water-soluble sheet according to claim 4, wherein the protrusion is a ridge, a cross shaped protrusion, and/or a hexagonal shaped protrusion.

17. The water-soluble sheet according to claim 4, wherein the depression is a groove, a cross shaped depression, and/or a hexagonal shaped depression.

18. The water-soluble sheet according to claim 4, wherein the protrusions and/or depressions have a centre to centre distance between adjacent protrusions and/or depressions of less than 2 μm.

19. The method according to claim 12, wherein at least one of the first or second films is a film according to claim 1.
